(19) United States
(12) Patent Application Publication
(10) Pub. No.: US 2020/0103542 A1
(43) Pub. Date: Apr. 2, 2020

(54) STRUCTURE SAFETY DETECTION SYSTEM AND METHOD THEREOF

(71) Applicant: Goldtek Technology Co., Ltd., New Taipei City (TW)

(72) Inventors: YEN-CHING LEE, New Taipei (TW); YU-CHANG SONG, New Taipei (TW); FU-YUAN TSAI, New Taipei (TW)

(21) Appl. No.: 16/220,302

(22) Filed: Dec. 14, 2018

(30) Foreign Application Priority Data
Sep. 30, 2018 (TW) 107134574

(51) Int. Cl. G01V 1/28; G01M 7/02; G01K 1/14; G01V 1/00

(52) U.S. Cl. CPC G01V 1/288; G01V 1/008; G01K 1/14; G01M 7/025

(57) ABSTRACT

A structure safety detection system includes a first sensor, a second sensor, and a server. The first sensor detects a wobble and slant state of a structure and generates a corresponding first detection result. The second sensor detects a characteristic width of the structure and generates a corresponding second detection result. The server analyzes the first detection result and the second detection result and generates a corresponding first analysis result.

### FIELD

The subject matter herein generally relates to structures, and more particularly to a structure safety detection system and method of detecting a safety state of a structure.

### BACKGROUND

Generally, structures located in earthquake zones or in faraway places need to be inspected regularly to determine the safety of the structure. Such inspections require lots of manpower, resources, and time to determine the safety of the structure.

### BRIEF DESCRIPTION OF THE DRAWINGS

Implementations of the present disclosure will now be described, by way of embodiment, with reference to the attached figures.

FIG. 1 is a block diagram of an embodiment of a structure safety detection system.

FIG. 2 is a block diagram of a second sensor mounted to a structure.

FIG. 3 is a block diagram of a server of the structure safety detection system as disclosed in FIG. 1.

FIG. 4 is a flowchart of a structure safety detection method for detecting safety of a structure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

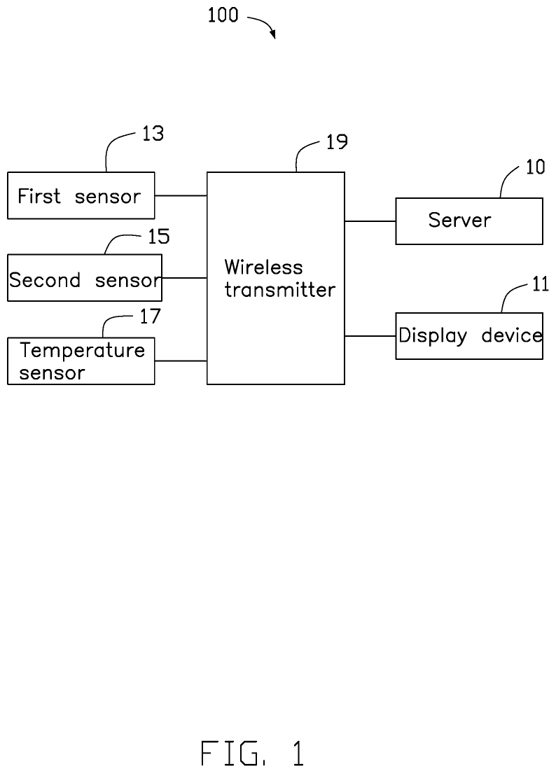

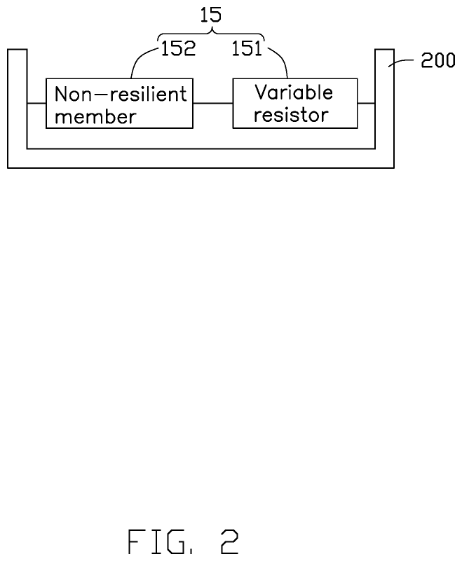

FIG. 1 shows an embodiment of a structure safety detection system 100 for analyzing safety of a structure 200 (shown in FIG. 2) according to a structural characteristic of the structure 200. The structure 200 may be a bridge, a room, or the like. The structural characteristic may be a space within the structure 200, such as a crack. In one embodiment, the structure 200 is a bridge, and the structural characteristic is a crack within the bridge.

The structure safety detection system 100 includes, but is not limited to, a server 10, a first sensor 13, a second sensor 15, a temperature sensor 17, and a wireless transmitter 19. The first sensor 13, the second sensor 15, the temperature sensor 17, and the wireless transmitter 19 are mounted on the structure 200. The structure 200 may have one of each or more than one of each of the first sensor 13, the second sensor 15, the temperature sensor 17, and the wireless transmitter 19.

The first sensor 13 detects a wobble and slant state of the structure 200 and generates a corresponding first detection result. The second sensor 15 detects a characteristic width of the structure 200 and generates a corresponding second detection result. The first sensor 13 is mounted to the structure 200 to detect the wobble and slant state of the structure 200. The second sensor 15 is mounted to the structure 200 to detect the characteristic width of the structure 200.

In one embodiment, the first sensor 13 is at least one of a gyroscope or an accelerometer. If the first sensor 13 is the accelerometer, the first sensor 13 can detect the wobble and/or slant state of the structure 200 and generate the first detection result when the structure 200 wobbles and/or slants. The first detection result may include an angle and/or speed of wobble and/or slant. If the first sensor 13 is the gyroscope, the first sensor 13 can detect the wobble and/or slant state of the structure 200 and generate the first detection result when the structure 200 wobbles and/or slants. The first detection result may include the angle of wobble and/or slant.

As shown in FIG. 2, in one embodiment, the second sensor 15 includes a variable resistor 151 and a non-resilient member 152. When a crack appears in the structure 200, the second sensor 15 may be mounted within the crack. in one embodiment, the non-resilient member 152 is coupled to the variable resistor 151. The non-resilient member 152 is mounted to a side of the crack, and the variable resistor 151 is mounted to another side of the crack. Thus, when the characteristic width of the structure 200 changes, a resistance value of the variable resistor 151 changes. The variable resistor 151 may be a sliding variable resistor. When the characteristic width of the structure 200 changes, the non-resilient member 152 coupled to the variable resistor 151 pulls the variable resistor 151 to change the resistance value of the variable resistor 151. The second sensor 15 calculates a change in the characteristic width of the structure 200 according to a change in the resistance value of the variable resistor 151. In the embodiment as disclosed, the second detection result presents the change in the characteristic width of the structure 200.

The temperature sensor 17 measures a temperature and a humidity at a location of the temperature sensor 17 and generates a corresponding third result. The third result represents the temperature and the humidity at a location of the temperature sensor 17. The temperature sensor 17 sends the third result through the wireless transmitter 19 to the server 10. The server 10 may determine whether the temperature and the humidity affect the structure 200. In one embodiment, the temperature and the humidity may influence rebar of the structure 200.

The wireless transmitter 19 receives the first detection result, the second detection result, and the third detection result, and sends the first detection result, the second detection result, and the third detection result to the server 10. The wireless transmitter 19 may be a LoRa wireless transmitter, an NB-IoT wireless transmitter, a Sigfox wireless transmitter, or the like. LoRa, NB-IoT, and Sigfox wireless transmitters have low power consumption and long transmission ranges. Thus, the structure safety detection system 100 may be used in structures 200 in isolated and faraway places.

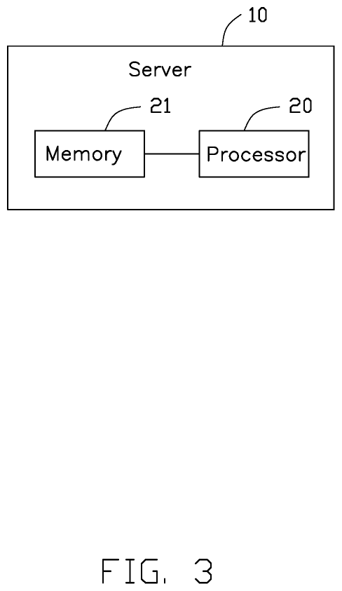

As shown in FIG. 3, the server 10 includes, but is not limited to, a processor 20 and a memory 21. The server 10 may be a computer, a workstation, a cloud server, or any device capable of storing data and executing programs.

The processor 20 can be a central processing unit, a microprocessing unit, or other data processing chip.

The memory 21 can be an internal storage of the server 10, or can be an external storage, such as a smart media card, a secure digital card, a flash card, or the like.

In one embodiment, the processor 20 analyzes a safety state of the structure 200 according to the first detection result and the second detection result and generates a corresponding first analysis result. Specifically, the processor 20 compares each of the first detection result and the second detection result to a corresponding predetermined detection result to analyze the safety state of the structure 200. The predetermined detection result corresponding to the first detection result and the second detection result respectively may be a largest wobble angle and/or a largest slant angle, and a largest characteristic width. In one embodiment, the processor 20 compares the first detection result to the largest slant angle and/or the largest wobble angle, and compares the second detection result to the largest characteristic width. When the first detection result and the second detection result are both less than the corresponding predetermined detection result, the first analysis result indicates that the structure 200 is safe. When any one of the first detection result and the second detection result is greater than the corresponding predetermined detection result, the first analysis result indicates that the structure 200 is unsafe.

In one embodiment, the processor 20 determines a first relationship between the temperature and the humidity at a location of the temperature sensor 17 and the characteristic width of the structure 200 according to the second detection result and the third detection result. The processor 20 generates a second analysis result according to the first relationship. The temperature sensor 17 can detect the temperature and the humidity at a location of the temperature sensor 17 multiple times, and the second sensor 15 can detect the characteristic width of the structure 200 each time the temperature sensor 17 detects the temperature and the humidity. The first relationship is a relationship between each time of detecting the temperature, the humidity, and the characteristic width of the structure 200. Thus, when the temperature and the humidity changes, the processor 20 generates the second analysis result according to a first relationship table.

In one embodiment, when a change in the temperature and the humidity at a location of the temperature sensor 17 cause a change in the characteristic width of the structure 200 to exceed the predetermined largest characteristic width, the second analysis result indicates that the structure 200 is unsafe. When the change in temperature and the humidity at a location of the temperature sensor 17 does not cause a change in the characteristic width, the second analysis result indicates that the structure 200 is safe.

In one embodiment, the memory 21 stores a magnitude of each time of an earthquake occurring at a location of the structure 200 and the characteristic width at the time of the earthquake. The processor 20 determines a second relationship between the magnitude of the earthquake and a change in the characteristic width caused by the earthquake. The processor 20 generates a third analysis result according to the second relationship to indicate whether the structure 200 is safe.

In one embodiment, before an earthquake occurs, the processor 20 determines the third analysis result according to the second relationship between the magnitude of earthquakes that have occurred in the past and the corresponding changes in the characteristic width of the structure 200. If the processor 20 determines that the change in the characteristic width of the structure 200 will exceed the largest characteristic width as a result of the earthquake, the third analysis result indicates that the structure 200 is unsafe. If the processor 20 determines that the change in the characteristic width of the structure 200 will not exceed the largest characteristic width as a result of the earthquake, the third analysis result indicates that the structure 200 is safe.

In another embodiment, the first relationship and the second relationship are combined to determine whether the characteristic width will be affected by changes in temperature and humidity and occurrence of an earthquake, thereby determining whether the structure 200 is safe or unsafe.

As shown in FIG. 1, the structure safety detection system 100 further includes a display device 11. The display device 11 displays a prompt indicating whether the structure 200 is safe or unsafe according to the first analysis result, the second analysis result, and/or the third analysis result. The prompt may be an audio prompt, a visual prompt, or a combination of the two.

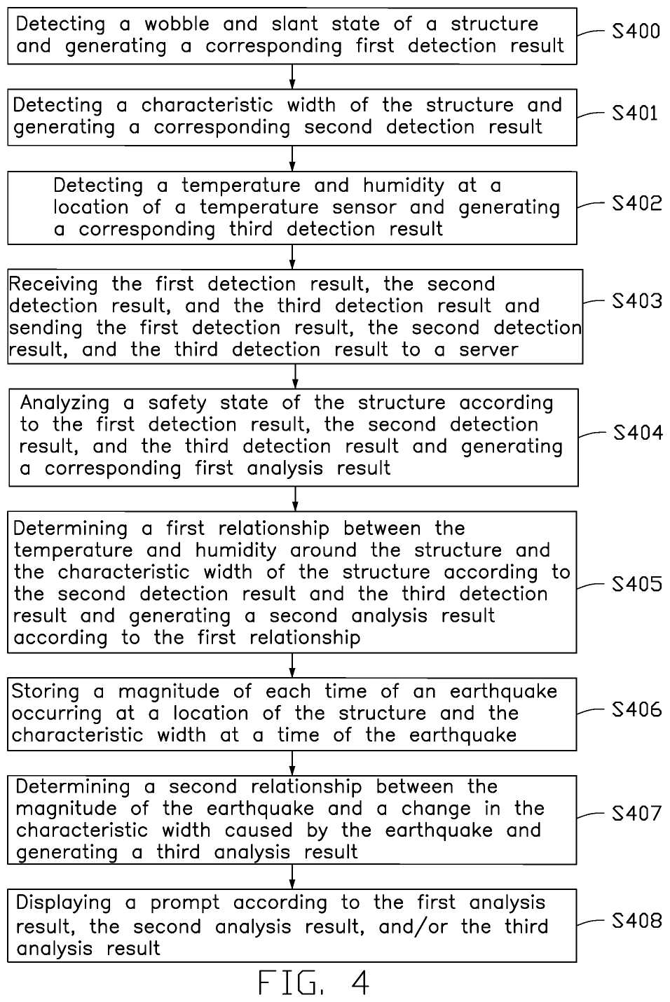

FIG. 4 illustrates a flowchart of an exemplary structure safety detection method for determining whether a structure 200 is safe. The method is provided by way of embodiments, as there are a variety of ways to carry out the method. The method described below can be carried out using the configurations illustrated in FIGS. 1-3, and various elements of these figures are referenced in explaining the embodiment. Each block shown in FIG. 4 represents one or more processes, methods, or subroutines carried out in the embodiment. Furthermore, the illustrated order of blocks is an embodiment, and the order of the blocks can be changed. Additional blocks can be added or fewer blocks can be utilized, without departing from this disclosure. The embodiment can begin at block S400.

At block S400, the first sensor 13 detects a wobble and slant state of the structure 200 and generates a corresponding first detection result. In one embodiment, the first sensor 13 is mounted on the structure 200 to detect the wobble and slant state of the structure 200.

At block S401, the second sensor 15 detects a characteristic width of the structure 200 and generates a corresponding second detection result. In one embodiment, the second sensor 15 is mounted on the structure 200 to detect the characteristic width.

At block S402, the temperature sensor 17 detects a temperature and a humidity at a location of the temperature sensor 17 and generates a corresponding third detection result. In one embodiment, one or more temperature sensors 17 may be mounted on the structure 200 to detect the temperature and the humidity at a location of the temperature sensor 17.

At block S403, the wireless transmitter 19 receives the first detection result, the second detection result, and the third detection result and sends the first detection result, the second detection result, and the third detection result to the server 10.

At block S404, the processor 20 of the server 10 analyzes a safety state of the structure 200 according to the first detection result, the second detection result, and the third detection result and generates a corresponding first analysis result. In one embodiment, the first analysis result indicates whether the structure 200 is safe or unsafe.

At block S405, the processor 20 determines a first relationship between the temperature and the humidity at a location of the temperature sensor 17 and the characteristic width of the structure 200 according to the second detection result and the third detection result. The processor 20 generates a second analysis result according to the first relationship. The second analysis result indicates whether the structure 200 is safe or unsafe.

At block S406, the memory 21 stores a magnitude of each time an earthquake occurred at the location of the structure 200 and the characteristic width at the time of the earthquake.

At block S407, the processor 20 determines a second relationship between the magnitude of the earthquake and a change in the characteristic width caused by the earthquake. The processor 20 generates a third analysis result according to the second relationship to indicate whether the structure 200 is safe.

At block S408, the display device 11 displays a prompt according to the first analysis result, the second analysis result, and/or the third analysis result. The display device 11 displays a prompt indicating whether the structure 200 is safe or unsafe according to the first analysis result, the second analysis result, and/or the third analysis result. The prompt may be an audio prompt, a visual prompt, or a combination of the two.

The structure safety detection system 100 as described above can determine a safety state of the structure 200 and send the first analysis result, the second analysis result, and the third analysis result to the server 10 to indicate whether structure 200 is safe or unsafe. Therefore, the safety of the structure 200 may be easily and quickly determined thereby saving manpower and time.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A structure safety detection system comprising:
a first sensor adapted for detecting a wobble and a slant state of a structure and generating a first detection result corresponding to the wobble and the slant state of the structure;
a second sensor adapted for detecting a characteristic width of the structure and generating a second detection result corresponding to the characteristic width of the structure; and
a server analyzing the first detection result and the second detection result and generating a first analysis result corresponding to the first detection result and the second detection result.

2. The structure safety detection system of claim 1 further comprising a temperature sensor adapted for sensing a temperature and a humidity at a location of the temperature sensor and generating a third detection result corresponding to the temperature and the humidity at the location of the temperature sensor, wherein:
the server determines a first relationship between the temperature and the humidity at a location of the temperature sensor and the characteristic width of the structure according to the second detection result and the third detection result; and
the server generates a second analysis result according to the first relationship.

3. The structure safety detection system of claim 2 further comprising a wireless transmitter adapted for receiving the first detection result, the second detection result, and the third detection result and sending the first detection result, the second detection result, and the third detection result to the server.

4. The structure safety detection system of claim 1, wherein:
the characteristic width of the structure is a width of a crack in the structure;
the first sensor is at least one of a gyroscope or an accelerometer;
the second sensor comprises a variable resistor and a non-resilient member, the non-resilient member being mounted to one side of the crack and coupled to the variable resistor mounted to another side of the crack;
a resistance of the resistor changes with a change in the characteristic width.

5. The structure safety detection system of claim 3, wherein:
the server comprises a memory storing a magnitude and a time of each earthquake at the location of the structure, and the characteristic width at the time of each earthquake;
the server determines a second relationship between the magnitude of the earthquake and a change in the characteristic width; and
the server generates a third analysis result according to the second relationship.

6. The structure safety detection system of claim 5 further comprising a display device displaying a prompt according to the first analysis result, the second analysis result, and/or the third analysis result.

7. A structure safety detection method comprising:
detecting, by a first sensor, a wobble and a slant state of a structure and generating a first detection result corresponding to the wobble and the slant state of the structure;
measuring, by a second sensor, a characteristic width of the structure and generating a second detection result corresponding to the characteristic width of the structure; and
analyzing, by a server, the first detection result and the second detection result and generating a first analysis result corresponding to the first detection result and the second detection result.

8. The structure safety detection method of claim 7 further comprising:
sensing, by a temperature sensor, a temperature and a humidity at a location of the temperature sensor and generating a third detection result corresponding to the temperature and the humidity at a location of the temperature sensor, wherein:
determining, by the server, a first relationship between the temperature and the humidity at a location of the temperature sensor and the characteristic width of the structure according to the second detection result and the third detection result; and
generating, by the server, a second analysis result according to the first relationship.

9. The structure safety detection method of claim 8 further comprising:
receiving, by a wireless transmitter, the first detection result, the second detection result, and the third detection result, and sending the first detection result, the second detection result, and the third detection result to the server.

10. The structure safety detection method of claim 8, further comprising:
storing, by the server, a magnitude and a time of each earthquake occurring at the location of the structure and the characteristic width at the time of each earthquake;
determining, by the server, a second relationship between the magnitude of the earthquake and a change in the characteristic width; and
generating, by the server, a third analysis result according to the second relationship.

11. The structure safety detection method of claim 10, wherein:
the characteristic width of the structure is a width of a crack in the structure;
the second sensor comprises a variable resistor and a non-resilient member, the non-resilient member being mounted to one side of the crack and coupled to the variable resistor mounted to another side of the crack;
a resistance of the resistor changes with a change in the characteristic width.

12. The structure safety detection method of claim 11 further comprising:
displaying, by a display device, a prompt according to the first analysis result, the second analysis result, and/or the third analysis result.
